(19) United States
(12) Patent Application Publication
(10) Pub. No.: US 2009/0086424 A1
(43) Pub. Date: Apr. 2, 2009

(54) Tri-layer folding laptop computer

(76) Inventor: Raymond Jette, Watertown, MA (US)

Correspondence Address: LAMBERT & ASSOCIATES, P.L.L.C., 92 STATE STREET, BOSTON, MA, 02109-2004, US

(21) Appl. No.: 11/906,013

(22) Filed: Oct. 1, 2007

(51) Int. Cl. G06F 1/16

(52) U.S. Cl. 361/679.55

(57) ABSTRACT

A tri-layer folding laptop computer having a first layer, a middle layer and a third layer, wherein the first layer includes a keyboard, the middle layer includes a lectern and the third layer includes a computer screen, such that an operator maintains an ergonomically correct sitting position during use thereby eliminating neck, shoulder, back and eye strain associated with prior art bi-layer designs.

### BACKGROUND OF THE INVENTION

1. Field of the Invention

The present invention relates generally to computers, and in particular to a tri-layer folding laptop computer with a built-in lectern that allows for an ergonomically correct operating posture by an individual user.

2. Description of the Related Art

The current design of laptop computers has created several problems over the years for users due mainly to functional limitations inherent in traditional two-layer construction, consisting of a screen hingedly connected to a computer base accommodating a keyboard.

Over the years, in an effort to make these laptop computers more compact and lightweight for portability, the computer manufacturers have inadvertently sacrificed comfortable ergonomic parameters of operation and long term use by individual users. Moreover, according to optometrists, the ideal focal distance most individuals prefer is in the visual range of twelve to fourteen inches from any viewing surface. Consequently, with the bi-fold design of current laptops with their keyboards positioned toward the rear of the computer base and the mouse panel situated forward, the operator is forced to lean forward with the arms suspended from the shoulders in order to both type on the keyboard and view the computer screen from a comfortable distance. The mechanical limitations inherent within this design essentially forces the operator to slump forward in an ergonomically incorrect operating position that ultimately strains the neck, shoulder and back muscles causing fatigue over time.

Additionally, in a majority of cases, operators of laptop computers usually require additional desktop space to accommodate additional paperwork and/or books to refer to while working. Consequently, by having to place these materials on a table top alongside the laptop computer in order to refer to them, the operator is forced into contorting the neck and upper body even further in order to view these items while working which contributes to the development of an even greater ergonomically incorrect working position that leads to additional neck and back muscle fatigue as well as eye strain.

The instant invention relates to a tri-layer folding laptop computer that includes a built-in lectern which creates a better working environment by allowing the operator to sit in a more ergonomically correct upright position as well as the ability to place adjunctive paperwork, music scores or books directly in front of the user while viewing the screen at approximately eye level.

Very few systems have been developed to address the problems an operator encounters during use of traditional laptop computers having only a screen for viewing screen hingedly connectable to a computer base fitted with a keyboard. Consequently, the current bi-fold design of laptop systems invariably places the viewing screen below eye level and at a less than optimal viewing distance that ultimately forces the operator to lean forward to type and to view the screen from an ergonomically undesirable sitting position.

It is therefore, the goal of the instant invention to correct the above-described problems an operator encounters during use of the traditional, bi-fold systems and, at the same time, optimize the use of available work space by incorporating a built-in lectern into the design. To this end, the preferred embodiment includes positioning the keyboard closest to the operator with the mouse panel positionable behind it in order to further facilitate ease of operation.

Presently, a large number of laptop computers, featuring differing styles, are known in the art and are widely used in the industry. But there does not exist in the art a tri-layer folding laptop computer that utilizes a built-in lectern, wherein the three folding layers consist of a viewing screen, a lectern for placing reading or work materials that are more easily accessible to the operator and a computer base with a standard size keyboard that will facilitate the operator's ability to maintain an ergonomically correct sitting position during operation of the laptop computer.

U.S. Pat. No. D443,598 to Katz discloses an ornamental design for a folding computer.

U.S. Pat. No. 5,949,643 to Batio discloses a folding, portable keyboard for a notebook computer consisting of two, pivotally-hinged halves. The two halves are hinged so that may be assume a perfectly flat, horizontal position or, alternatively, a laterally raised and sloping configuration that provides an enhanced, ergonometric configuration to the user. Furthermore, each half has its own set of keys and space bar.

U.S. Pat. No. 6,643,124 to Wilk discloses a portable computing device equipped with multiple display panels. The display panels are hinged, jointed or otherwise disposed to rotate or slide with respect to one another in a transition from a compact configuration to an expanded configuration. Therefore, in the inventions most basic embodiment three output screens take a form of a triptych for which an input panel forms a base. The output panels are deployed with a bend when opened and the images are angled in towards an observer.

U.S. Pat. No. 6,913,332 to Besterfield et al. discloses a retracting keyboard and monitor platform wherein a lift mechanism is utilized to lift a monitor, vertically, from the back of the desk. Thus, when a user is done using the system, the screen retracts and disappears.

U.S. Pat. No. 6,490,154 to Thompson discloses a mobile computer docking mechanism which transforms a laptop computer into a fully capable desktop computing and telephony system. The invention facilitates the use of the laptop liquid crystal display screen while the laptop computer is in the docked position. The network, keyboard and power ports are connected in the docked position, and the entire desktop configuration has a very low profile taking up very little desktop space. The upright position and design facilitates proper docking and an adjustable ergonomic viewing position, elevation as well as angularity.

U.S. Pat. No. 6,556,435 to Helot, et al. discloses a height adjustable docking station and a mobile computing device for use therewith. The docking station includes a structure for receiving the screen of a mobile computing device. The structure for receiving the screen is coupled to a docking station body such that the height and viewing angle of the screen in the structure can be adjusted.

In summary, investigation of these disclosed devices illustrates that presently, there is no single device known in the art that meets the requirements of a tri-layer folding laptop computer as nothing in the prior art discloses a laptop computer that utilizes a three layer structure including a viewing screen, a built-in lectern and a keyboard.

### SUMMARY OF THE INVENTION

The present invention, as described further herein, imparts a novel laptop computer which encompasses the advantages of other laptop computers, but includes a tri-layer folding design that includes a built-in lectern, thereby allowing the operator to maintain an ergonomically correct, upright sitting position during use, thus overcoming problems created by the traditional bi-fold design. The instant invention, as illustrated herein, is clearly not anticipated, rendered obvious, or even present in any of the prior art mechanisms, either alone or in any combination thereof.

The primary object of the present invention is to provide a tri-layer folding laptop computer with a built-in lectern as the central component of the three layered configuration, wherein the laptop computer is unfolded to form three distinct surfaces, a computer base with a keyboard, a lectern and a viewing screen.

Another object of the present invention is to provide a tri-layer folding laptop computer with a built-in lectern that serves as a work surface for the placement of papers, music scores, books etc.

Another object of the present invention is to provide a tri-layer, laptop computer where the built-in lectern of the middle layer also serves the function of an elongated hinge preferably equal to the side dimension of the computer base that elevates and supports the viewing screen at approximately eye level and at varying focal distances.

Another object of the present invention is to provide a tri-layer folding laptop computer that creates a more ergonomically correct working environment by allowing the operator to work in a more ergonomically correct upright sitting/operating position.

Another object of the present invention is to provide a tri-layer folding laptop computer that allows the operator the flexibility to adjust the focal distance and tilt of the computer screen forward or backward along a horizontal plane that is approximately at eye level in order to optimize viewing comfort.

Another object of the present invention is to provide a tri-layer folding laptop computer that eliminates neck, shoulder, back and eye strain associated with long-term use of traditional bi-fold design laptop computers.

Another object of the present invention is to provide a tri-layer folding laptop computer wherein the lectern can be modified to form a compartment for storing documents, a remote mouse, speakers and/or other accessory components and which also can be opened to provide an extended lectern surface for music score sheets etc.

Another object of the present invention is to provide a tri-layer folding laptop computer that places the keyboard in a forward position closest to the operator with the mouse panel positioned behind it for added typing comfort.

There has thus been outlined, rather broadly, the more important features of the tri-layer folding laptop computer in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a diagrammatic perspective view of a tri-layer folding laptop computer having three distinct surfaces, including a base portion with a keyboard, a lectern portion and a viewing screen.

FIG. 2 is a profile view of the tri-layer folding laptop computer having three distinct surfaces, while also including additional support members for overall stability.

FIG. 3 is a diagrammatic perspective view of the tri-layer folding laptop computer in use, wherein a book or other reading material is placeable on the lectern portion enabling an individual to easily refer to the reading material during operation of the laptop computer.

FIG. 4 is a profile view of the tri-layer folding laptop computer in use, wherein a book or other reading material is placeable on the lectern portion, and wherein the additional support members are deployed to both support the reading material and the overall laptop computer during operation.

FIG. 5 is a diagrammatic perspective view of tri-layer folding laptop computer, wherein the laptop computer is in the closed position; having each of the three layers folded on top of each other when the computer is no longer in operation.

FIG. 6 is a diagrammatic perspective view and comparison of the prior art bi-fold laptop computer design in use versus the instant invention in use displaying the ergonomic benefits for an individual during operation of the tri-layer folding computer.

FIG. 7 is a profile view of the tri-layer folding laptop computer demonstrating the flexibility of being able to place the viewing screen at a variety of focal distances from the operator along a horizontal plane that is approximately at eye level as well as offering the option of being able to tilt the screen to a variety of angles in order to optimize visual comfort.

FIG. 8 is a diagrammatic perspective view of a tri-layer folding laptop computer having three distinct surfaces wherein the lectern portion has been modified to form a compartment for the storage of documents, a thin remote mouse, or other accessories and in addition, can be opened to form an expanded lectern surface for music score sheets, other reading materials or installed speakers.

FIG. 9 is a diagrammatic perspective view of the tri-layer folding laptop computer demonstrating the lectern portion modified into a compartment for storing documents while in the closed position; having each of the three layers folded on top of one another when the computer is no longer in operation.

### DETAILED DESCRIPTION OF THE PREFERRED EMBODIMENTS

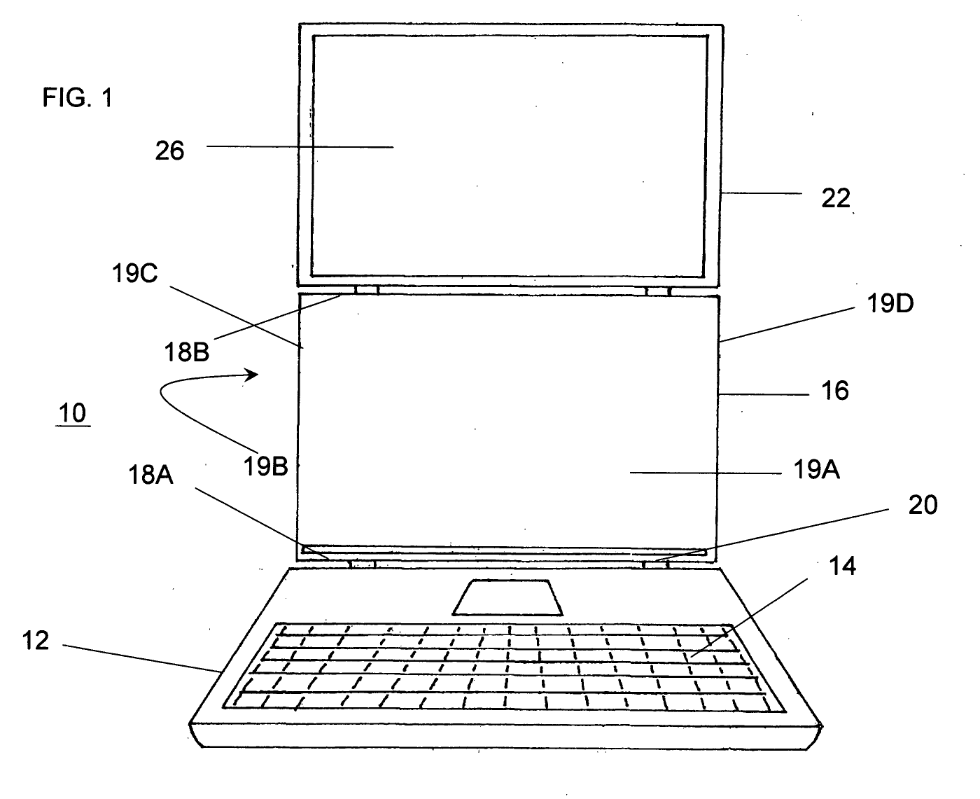

FIG. 1 illustrates a tri-layer folding laptop computer 10 that includes three distinct sections to create a better working environment for an operator and allows for the operator to maintain an ergonomically correct upright sitting position during use as opposed to the prior art bi-fold design laptop computers referenced above. The laptop computer 10 includes a first layer 12 that preferably consists of a computer base with a keyboard 14 as known in the computer arts and rests upon the work surface, similar to the prior art bi-fold design. A middle layer 16 having a first end 18A and a second end 18B, wherein the first end 18A of the middle layer 16 is connectable to the first layer 12 by a fastening means 20 as known in the computer arts. The middle layer 16 further includes a front 19A, a back 19B, a first side 19C and a second side 19D. The middle layer 16 preferably serves as a built-in lectern and an additional work surface for the placement of books, papers or music scores etc. to aide the operator during use of the laptop computer 10. A third layer 22 is connectable to the second end 18B of the middle layer 16 by fastening means 20, that preferably consists of a standard computer screen 26 as known in the computer arts. Preferably the fastening means 20 of the computer 10 include the layers 12, 16 and 22 being hingedly connectable to each other.

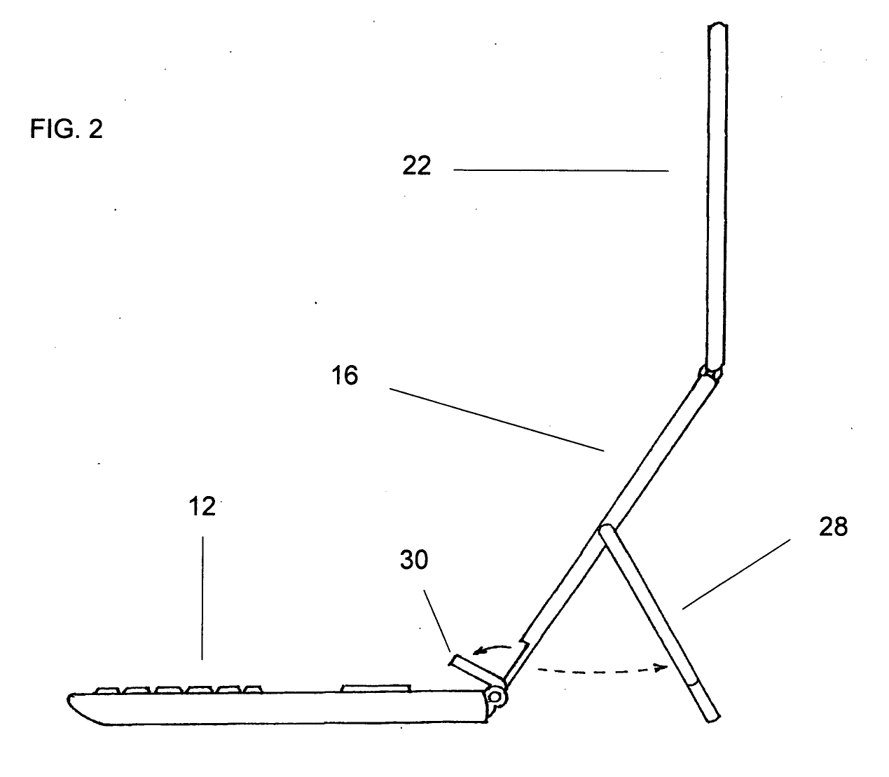

FIG. 2 illustrates a profile view of the tri-layer folding laptop computer 10, wherein the computer 10 includes several support members to distribute and receive the overall weight of the computer 10 while in use. A support arm 28 is hingedly connectable to the middle layer 16 of the computer 10 such that the support arm 28 rearwardly extends to support the middle layer 16 and third layer 22 of the computer 10. Preferably the support arm 28 is connectable to the middle layer 22 of the computer 10 at the first and second sides 19C and 19D allowing for rearward extension. Preferably the support arm 28 is equidistantly spaced between the first and second end 18A and 18B of each side 19C and 19D of the middle layer 16; however alternative locations of the support arm 28 are suitable. Alternatively the support arm is attachable to the back 19B of the middle layer 16 of the computer 10 to distribute and support the weight of the middle layer 16 and third layer 22. The laptop computer 10 also includes a lectern retractable rest 30 hingedly connectable to the middle layer 16 of the computer 10 such that the lectern support arm 30 inwardly extends to a support a book or any other reading material which is placeable on the middle layer 16. Preferably the lectern retractable rest 30 is connectable to the middle layer of the computer 10 at the first end 18A of each side 19C and 19D of the middle layer 16 of the computer 10.

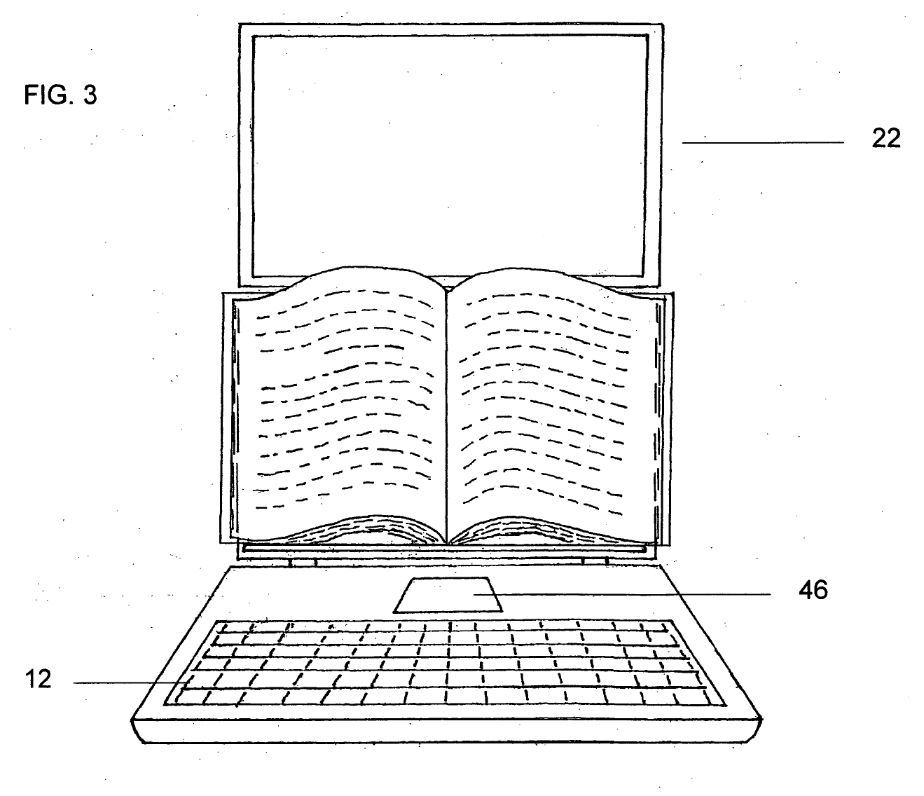

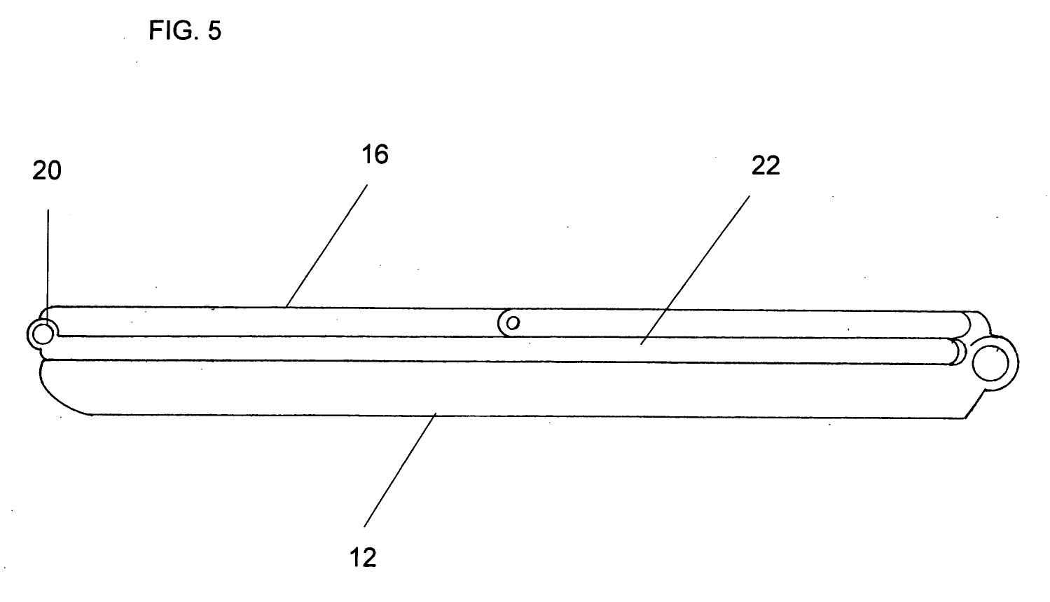

FIG. 3 illustrates the laptop computer 10 in use wherein a book or other similar piece of reading material has been placed against the middle layer 16. In this embodiment, the laptop computer 10 possesses the functionality of the prior art bi-fold design having both the computer screen 26 and keyboard 14, but with the addition of middle layer 16 that serves as a lectern for books and other reading materials. In an alternate embodiment, the computer 10 possesses a compartment 50 for carrying a remote mouse or other accessory components. In addition, the middle layer 16 may be modified to allow for documents to be situated there when the computer 10 is completely folded (see FIG. 5). In the preferred embodiment, the keyboard 14 locatable in the first layer 12 of the computer 10 is in a forward position closest to the operator with the mouse 46 positionable behind the keyboard 14 and further away from the operator. This configuration permits a more comfortable access to the keyboard 14 when sitting in an upright, more ergonomically correct position. An alternate embodiment of the instant invention 10 includes a keyboard 14 that is a standard keyboard with standard sized keys as known in the computer arts that is associated with a desktop computer.

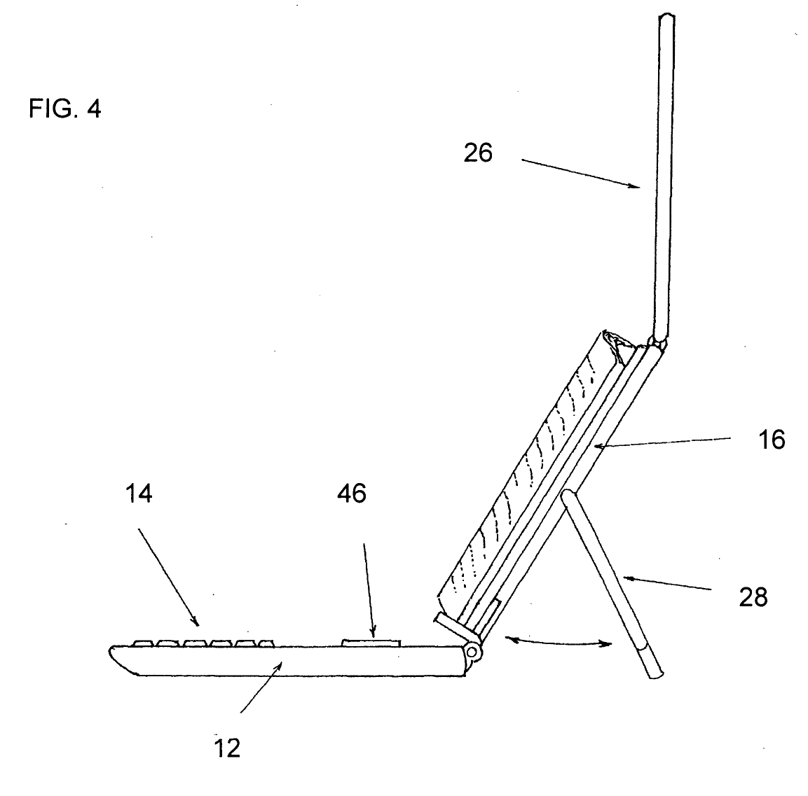

FIG. 4 illustrates a profile view of the laptop computer 10 in use wherein a book or other similar piece of reading material has been placed against the middle layer 16. In this embodiment, both the support arm 28 and the lectern retractable rest 30 have been deployed to provide support, stability and distribute the weight of the middle and third layers 16 and 22 of the computer 10.

FIG. 5 illustrates the laptop computer 10 in a completely folded state wherein the third layer 22 sits between the middle layer 16 and the first layer 12 when not in use by an operator. Therefore, when the computer 10 is not in use, an operator may simply configure the different sections of the computer 10 into the folded state for ease of portability between destinations.

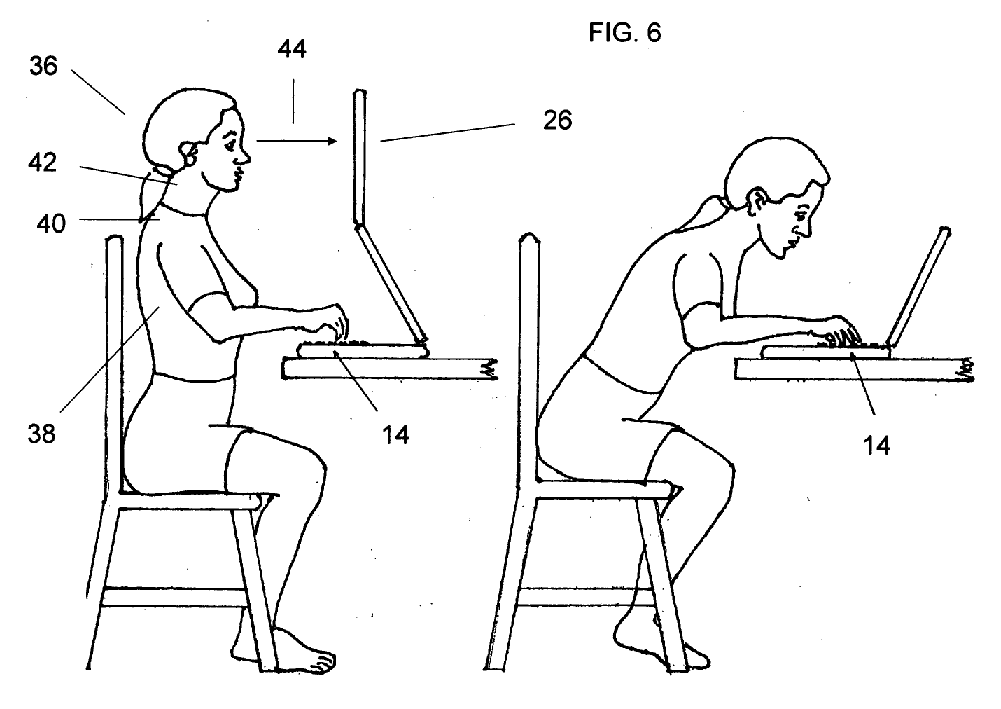

FIG. 6 illustrates a side-by-side view comparison of the tri-layer folding laptop computer 10 and the prior-art traditional bi-fold design. As can be seen from the prior art, when in use, an operator 36 having a back portion 38, a pair of shoulders 40 and a neck 42 is required to lean the neck 42 and back 38 forward to obtain the optimal reading distance from the computer screen 26 as well as to be able to type on the rear-positioned keyboard 14. Therefore, the prior art bi-fold design causes the operator 36 to slump forward and endure an ergonomically incorrect operating position that strains the neck 42, back 38 and shoulders 40 causing muscle fatigue over time. In contrast, the instant invention 10 allows the operator 36 to maintain an ergonomically correct position during use of the computer 10 by viewing the computer screen 26 at approximately eye level and having the option of adjusting the focal distance and tilt of the computer screen 26 forward or backward along a horizontal plane to optimize viewing comfort. Therefore the instant invention 10 allows for the operator 36 to maintain a line of sight 44 substantially perpendicular to a perfectly erect back 38.

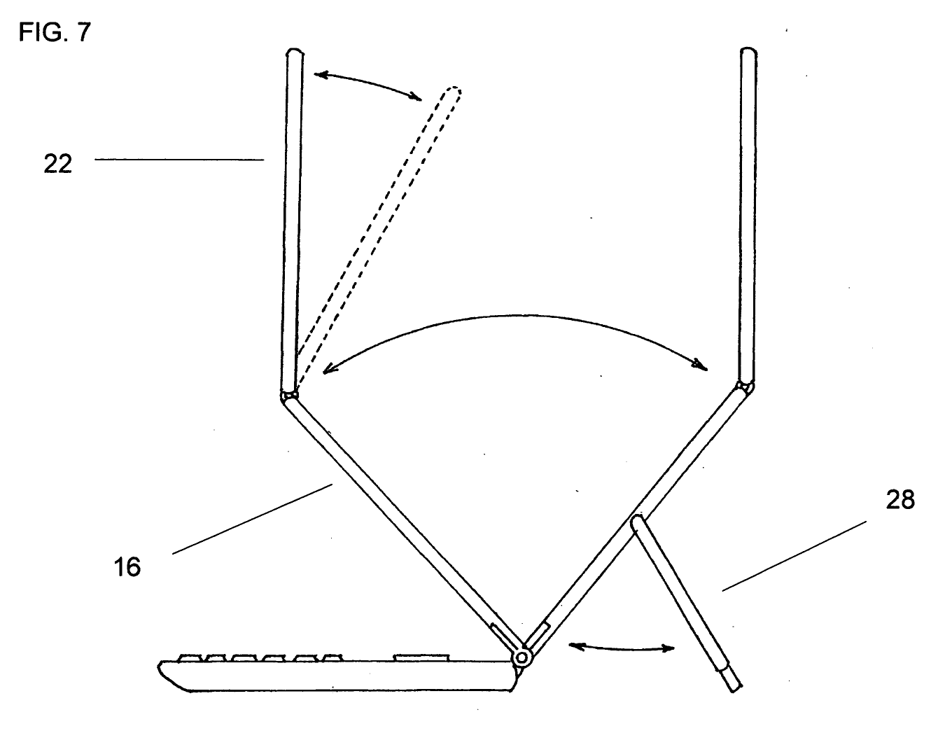

FIG. 7 illustrates the adjustability of the instant invention 10 wherein the middle layer 16 includes an adjustability range of greater than ninety degrees in the frontward and backward directions. Therefore, the instant invention 10 allows the operator 36 to move both the middle layer 16 and third layer 22 to different positions and angles achieving the most comfortable and ergonomically correct position for each individual operator 36.

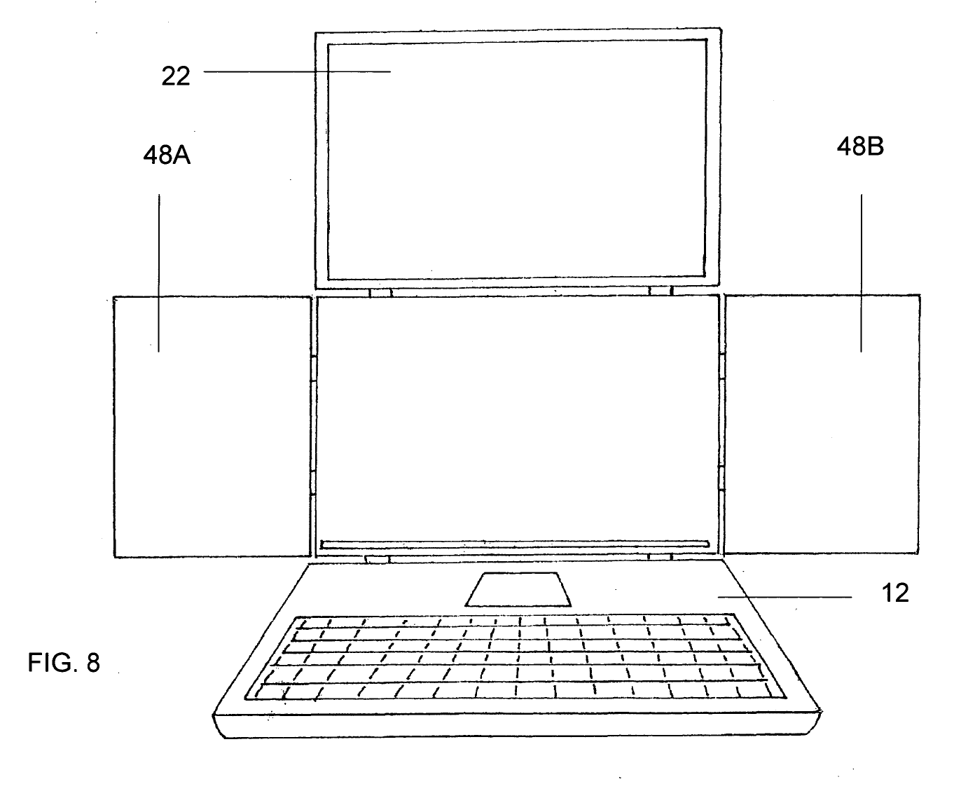

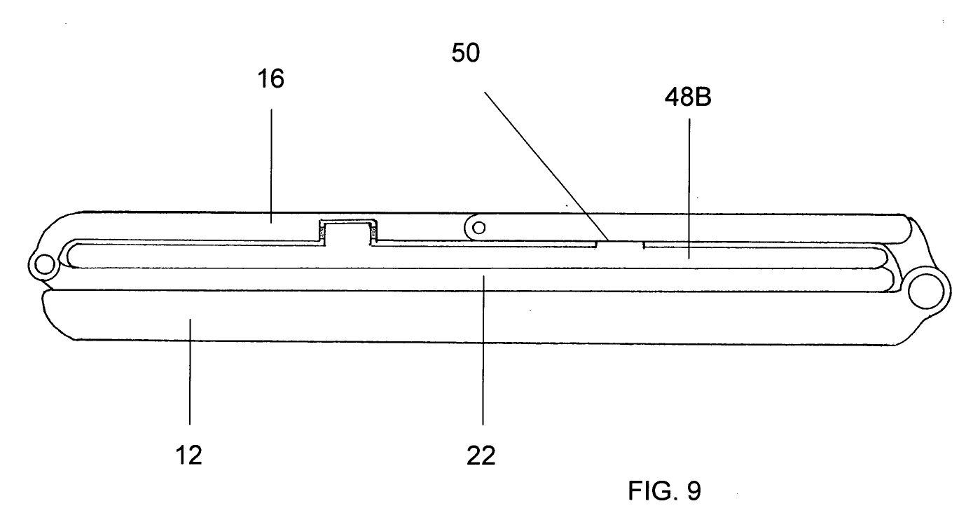

FIG. 8 illustrates an alternate embodiment of the instant invention 10 wherein the middle layer 16 includes a first and second flap 48A and 48B such that the flaps 48A and 48B when in the open position are able to expand the working space of the middle layer 16 that serves as the lectern portion of the instant invention 10 for the placement of reading materials and other items. The first flap 48A is hingedly connectable to the first side 19C of the middle layer 16 and the second flap 48B is hingedly connectable to the second side 19D of the middle layer 16. When this embodiment is in the closed position (see FIG. 9), the first and second flaps 48A and 48B form a compartment 50 that can be used to store documents, a remote mouse or other accessories.

FIG. 9 illustrates the instant invention 10 in a closed position wherein the first and second flaps 48A and 48B are folded into the middle layer 16 for portability.

The instant invention 10 includes all of the components of the standard prior art bi-fold design laptop computers as known in the computer arts although not disclosed herein.

While several embodiments of the present invention have been illustrated by way of example, it is apparent that further embodiments could be developed within the spirit and scope of the present invention. However, it is to be expressly understood that such modifications and adaptations are within the spirit and scope of the present invention, as set forth in the following claims.

What is claimed is:

1. A tri-layer folding laptop computer which allows an operator to sit in an ergonomically correct operating position while viewing a computer screen at approximately the eye level of the operator and allows the operator to adjust the various layers of the laptop computer to optimize viewing comprising:
a first layer;
a middle layer having a first end and a second end, wherein the first end of the middle layer is connectable to the first layer by a fastening means; and
a third layer, wherein the third layer is connectable to the second end of the middle layer by a fastening means.

2. The laptop computer of claim 1, wherein the first layer includes a front, a back, a first side and a second side, the middle layer includes a front, a back, a first side and a second side, and the third layer includes a front, a back, a first side and a second side.

3. The laptop computer of claim 2, wherein the first layer includes a keyboard.

4. The laptop computer of claim 3, wherein the keyboard is positionable in front of a mouse panel such that the keyboard is in a position closest to the operator to facilitate a more ergonomically correct typing position.

5. The laptop computer of claim 4, wherein the third layer includes a computer screen.

6. The laptop computer of claim 5, wherein the fastening means further comprises the layers being hingedly connectable to each other.

7. The laptop computer of claim 6, wherein a plurality of support members are placeable upon the laptop computer to distribute and receive the overall weight of the computer.

8. The laptop computer of claim 7, wherein a support arm is hingedly connectable to the middle layer such that the support arm rearwardly extends.

9. The laptop computer of claim 8, wherein the support arm is connectable to the middle layer along the first and second sides.

10. The laptop computer of claim 9, wherein the support arm is equidistantly spaced between the first and second end of each side of the middle layer.

11. The laptop computer of claim 10, wherein a lectern retractable rest is hingedly connectable to the middle layer such that the lectern retractable rest inwardly extends.

12. The laptop computer of claim 11, wherein the lectern retractable rest is connectable at the first end of each side of the middle layer.

13. The laptop computer of claim 12, wherein the middle layer includes a first and second flap creating an expandable workspace for the middle layer.

14. The laptop computer of claim 13, wherein the first flap is hingedly connectable to the first side of the middle layer, and the second flap is hingedly connectable to the second side of the middle layer.

15. The laptop computer of claim 14, wherein the first and second flaps create a compartment for storing documents and other items when the first and second flaps are folded into the middle layer.

16. The laptop computer of claim 15, wherein an operator having a back, a neck and a pair of shoulders maintains an ergonomically correct operating position during use of the computer.

17. The laptop computer of claim 16, wherein the operator maintains a line of sight substantially perpendicular to the operators back during use of the computer.

18. The laptop computer of claim 17, wherein the middle layer includes an adjustability range of greater than ninety degrees in the frontward and backward directions.

19. The laptop computer of claim 18, wherein the keyboard locatable in the first layer is a standard keyboard with standard size keys.

20. The laptop computer of claim 19, wherein the built-in lectern of the middle layer functions as an elongated hinge that elevates and supports the viewing screen at approximately eye level and at varying focal distances.
